(19) United States
(12) Patent Application Publication
(10) Pub. No.: US 2017/0153951 A1
(43) Pub. Date: Jun. 1, 2017

(54) INCREMENTAL SYNCHRONOUS HIERARCHICAL SYSTEM RESTORATION

(71) Applicant: Microsoft Technology Licensing, LLC, Redmond, WA (US)

(72) Inventor: Richard Paul Testardi, Boulder, CO (US)

(21) Appl. No.: 14/954,648

(22) Filed: Nov. 30, 2015

(51) Int. Cl. G06F 11/14; G06F 17/30

(52) U.S. Cl. CPC G06F 11/1469; G06F 17/30221; G06F 2201/80

(57) ABSTRACT

An incremental synchronous hierarchical system restoration system. A hierarchical system, such as a file system, that has an incompletely populated hierarchy, such as a directory structure, is incrementally restored in response to each of at least some successive hierarchical system commands. For instance, in some embodiments, the hierarchical system restoration may be a just-in-time hierarchical system restoration that restores portions of the hierarchical system hierarchy just in time to provide the visualizations used for each hierarchical system command response. By so doing, the restoration system provides the illusion that the hierarchical system has already been restored since the appropriate visualization and functionality is provided in response to each hierarchical system command, just as a fully populated hierarchical system would. The manner of acquiring and populating file system hierarchies is especially efficient so as to make such restoration possible in substantial real-time.

### BACKGROUND

Computing systems often organize data into a hierarchical structure. For instance, file systems hierarchically organize files into directory structures. Databases are hierarchical in which individual records may be considered leaf nodes in the hierarchy, with upper levels in the hierarchy being groups of records and/or other groups. However, many other types of data are organized hierarchically as well.

In the case of a file system, an internal node in the hierarchical structure is a directory, whereas a leaf node in the hierarchical structure is a file (or perhaps rarely an empty directory). File systems often include operational files (e.g., executable files, or data files) for use by the operating systems and/or applications running thereon, or may include user data files (e.g., word processing documents, game save files, pictures, video, music, and the like).

Remote backup services offer to backup all or portions of hierarchical systems remotely. For instance, in a file system, the files may be compressed on the local system, dispatched to a remote location, and stored. Once backed up, file systems may also be restored. Typically, when a file system is restored, often the entire hierarchy of the hierarchical structure (e.g., the directory structure) is restored, along with its contents, although some of the files may indeed be sparsely populated.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to an incremental synchronous hierarchical system restoration system. A hierarchical system (e.g., a file system) that has an incompletely populated hierarchy (e.g., an incompletely populated directory structure) is incrementally restored in response to each of at least some successive hierarchical system commands. For instance, in some embodiments, the hierarchical system restoration may be a just-in-time hierarchical system restoration that restores portions of the hierarchical system hierarchy just in time to provide the responses used for each hierarchical system command response. By so doing, the restoration system provides the illusion that the hierarchical system has already been restored since the appropriate visualization and functionality is provided in response to each hierarchical system command, just as a fully populated hierarchical system would, except with perhaps some slight latency to account for retrieval of hierarchy portions from remote locations, such as a cloud computing environment.

The restoration system includes a hierarchical system command interception component that is structured to respond to hierarchical system commands to the incompletely populated hierarchical system hierarchy by first determining whether or not a visualization of a response to the hierarchical system command can be rendered based on the present population level of the hierarchical system hierarchy. If so, the hierarchical system command can be passed to the hierarchical system without further ado. If not, the interception component identifies data that would increase the local hierarchical system to a higher population level that could be used to render the response to the hierarchical system command. Furthermore, the interception component obtains the identified data from a remote location (such as a cloud computing environment) and further populates the local hierarchical system hierarchy to the higher population level. Then, the hierarchical system command is passed to the hierarchical system which is now sufficiently populated such that the response may be visualized, just as if the hierarchical system was already fully restored. This incremental restoration may continue as more and more hierarchical system commands are intercepted. In many cases, large portions of the hierarchical system hierarchy may never be restored because they are never needed in response to a hierarchical system command, but the requestor is none the worse for wear since the requestors have received the proper responses the same as if the hierarchical system was fully populated. Accordingly, there is the potential for improved bandwidth utilization and better use of local memory and storage resources. Furthermore, this improved use of bandwidth may be accomplished without actually changing the hierarchical system itself. Rather, the interception component simply ensures that the hierarchical system hierarchy is sufficiently populated such that the hierarchical system itself can respond. Accordingly, the hierarchical system command interception component itself need not actually generate the response to the command.

As an example, in one embodiment, the hierarchical system may be a file system. For instance, the file system may begin with an empty directory corresponding to a particular time (e.g., a root directory). Alternatively, a subdirectory may begin empty corresponding to each of multiple backups of the file system hierarchy. As file system commands are received, the file system hierarchy associated with the path name is restored. If a directory command is issued, metadata associated with the contents of the directory may be retrieved by the interception component and populated to the file system, allowing the file system to thereby respond to the directory command, thereby providing the illusion that all contents are fully available in that directory. In some embodiments, the manner of acquiring and populating file system hierarchies is especially efficient so as to make such restoration particularly efficient, and potentially make restoration possible with minimal latency imposed on each command.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed.

FIG. 2 illustrates an environment in which an incremental synchronous hierarchical system restoration system receives a series of hierarchical system commands from one or more requestors and incrementally restores the hierarchical system in response to each of at least some of the hierarchical system commands;

FIG. 3 illustrates a flowchart of a method for a hierarchical system command interception component to provide an appearance of a populated hierarchical system hierarchy even for a local hierarchical system having an incompletely populated hierarchy;

FIG. 4A represents an example file system hierarchy as it would appear if fully restored;

FIG. 4B represents an example simplified representation of the file system hierarchy of FIG. 4A is it exists in this example before file system commands are received at the file system command interception component;

FIGS. 4C through 4F illustrates various further incrementally restored file system hierarchy states as they exist in response to subsequent incremental restoration of the file system;

FIGS. 4G and 4H illustrated various further changes that may occur when operating on contents of directories that have not yet been populated into the restored file system hierarchy;

FIG. 5 illustrates a flowchart of a method for augmenting a file system hierarchy using the file system path;

FIG. 6 illustrates a hierarchical system backup environment in accordance with one embodiment of the principles described herein;

FIG. 7 illustrates a flowchart of a method for backing up a hierarchical system, which method may be performed by the backup environment of FIG. 6;

FIG. 8 illustrates a method for formulating an injected representation of a parent node in the hierarchical system, which method may be recursively repeated for each non-leaf node in the hierarchical system hierarchy;

FIG. 9 illustrates an example environment that shows an example hierarchical system, in the form of a file system, hierarchy being backed up into the cloud blob storage;

FIG. 10 illustrates a method for providing the injected representations for hierarchical system nodes into the cloud;

FIG. 11 illustrates a flowchart of a method for updating content of a parent node in response to a change in a child node; and

FIG. 12 illustrates a modified environment that represents a modification of the environment of FIG. 9.

### DETAILED DESCRIPTION

At least some embodiments described herein relate to an incremental synchronous hierarchical system restoration system. A hierarchical system (e.g., a file system) that has an incompletely populated hierarchy (e.g., an incompletely populated directory structure) is incrementally restored in response to each of at least some successive hierarchical system commands. For instance, in some embodiments, the hierarchical system restoration may be a just-in-time hierarchical system restoration that restores portions of the hierarchical system hierarchy just in time to provide the responses used for each hierarchical system command response. By so doing, the restoration system provides the illusion that the hierarchical system has already been restored since the appropriate visualization and functionality is provided in response to each hierarchical system command, just as a fully populated hierarchical system would, except with perhaps some slight latency to account for retrieval of hierarchy portions from remote locations, such as a cloud computing environment.

The restoration system includes a hierarchical system command interception component that is structured to respond to hierarchical system commands to the incompletely populated hierarchical system hierarchy by first determining whether or not a visualization of a response to the hierarchical system command can be rendered based on the present population level of the hierarchical system hierarchy. If so, the hierarchical system command can be passed to the hierarchical system without further ado. If not, the interception component identifies data that would increase the local hierarchical system to a higher population level that could be used to render the response to the hierarchical system command. Furthermore, the interception component obtains the identified data from a remote location (such as a cloud computing environment) and further populates the local hierarchical system hierarchy to the higher population level. Then, the hierarchical system command is passed to the hierarchical system which is now sufficiently populated such that the response may be visualized, just as if the hierarchical system was already fully restored. This incremental restoration may continue as more and more hierarchical system commands are intercepted. In many cases, large portions of the hierarchical system hierarchy may never be restored because they are never needed in response to a hierarchical system command, but the requestor is none the worse for wear since the requestors have received the proper responses the same as if the hierarchical system was fully populated. Accordingly, there is the potential for improved bandwidth utilization and better use of local memory and storage resources. Furthermore, this improved use of bandwidth may be accomplished without actually changing the hierarchical system itself. Rather, the interception component simply ensures that the hierarchical system hierarchy is sufficiently populated such that the hierarchical system itself can respond. Accordingly, the hierarchical system command interception component itself need not actually generate the response to the command.

As an example, in one embodiment, the hierarchical system may be a file system. For instance, the file system may begin with an empty directory corresponding to a particular time (e.g., a root directory). Alternatively, a subdirectory may begin empty corresponding to each of multiple backups of the file system hierarchy. As file system commands are received, the file system hierarchy associated with the path name is restored. If a directory command is issued, metadata associated with the contents of the directory may be retrieved by the interception component and populating into the file system, allowing the file system to thereby respond to the directory command, thereby providing the illusion that all contents are fully available in that directory. In some embodiments, the manner of acquiring and populating file system hierarchies is especially efficient so as to make such restoration particularly efficient, and potentially make restoration possible with minimal latency imposed on each command.

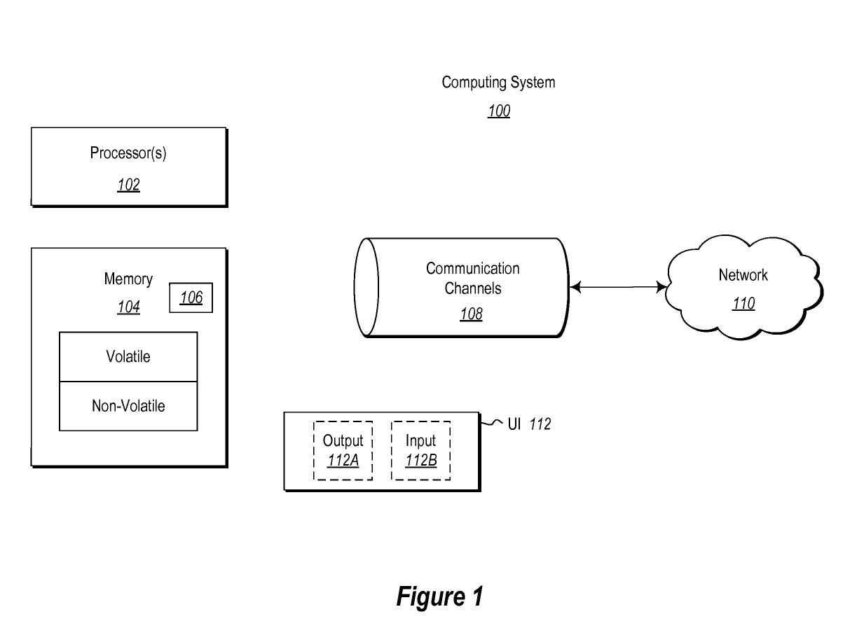

Some introductory discussion of a computing system will be described with respect to FIG. 1. Then, the structure and operation of the incremental synchronous hierarchical system restoration system will be described with respect to subsequent figures.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

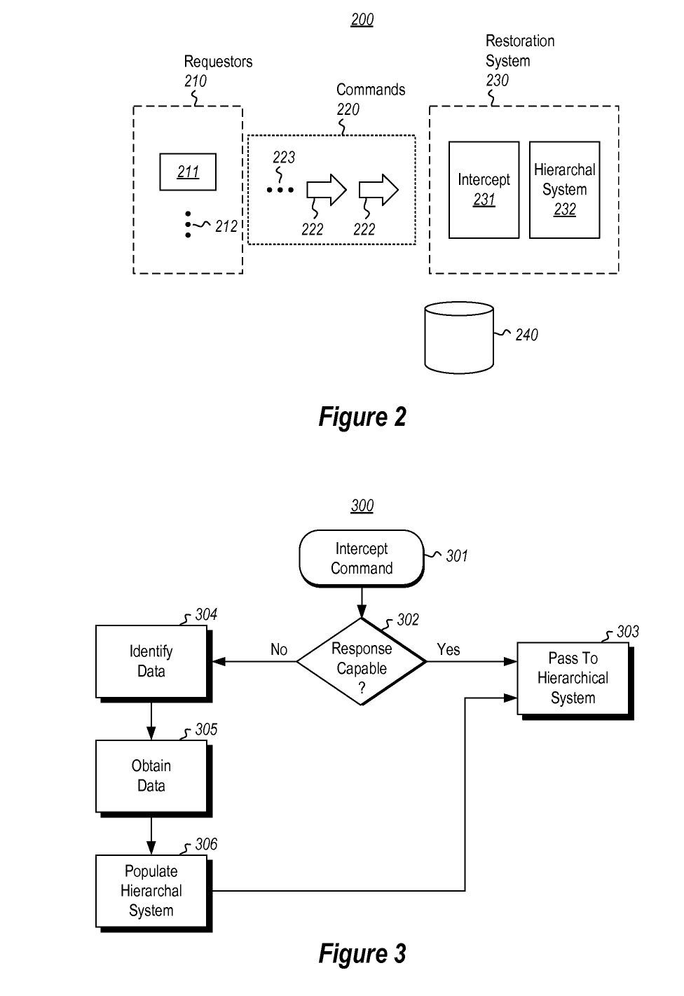

FIG. 2 illustrates an environment 200 in which the principles described herein may be employed. The environment 200 includes an incremental synchronous hierarchical system restoration system 230 (also called herein simply “restoration system”) that receives hierarchical system commands 220 from requestors 210. The restoration system 230 includes a hierarchical system command interception component 231 that is structured to respond to hierarchical system commands issued to a hierarchical system 232 that has an incompletely populated hierarchy.

One example called hereinafter the “file system example”, the hierarchical system 232 is a file system, with the corresponding hierarchy being a directory structure with each directory populated by zero or more files. That said, the principles described herein may be applied to any hierarchical system that includes a hierarchy of nodes. The file system example will be used hereinafter as the file system is one of the most commonly used hierarchical systems, particularly for casual computer users, and thus the file system is an intuitive example to use in this description. In the file system example, the hierarchical system commands 220 are file system commands, and the requestors 210 are users or software that uses the file system. Because the file system example is used extensively hereinafter, the hierarchical system commands 220 will also be referred to as “file system commands 220”, the restoration system 230 may also be referred to as “file system restoration system 230”, the hierarchical system command interception component 231 will also be referred to as a “file system command interception component 231”, and the hierarchical system 232 will also be referred to as a “file system 232”. This is exclusively for purposes of the file system example, as the principles described herein are intended to extend to the restoration of any hierarchical system.

The file system restoration system 230 may serve any number of requestors. Accordingly, although the requestors 210 are illustrated as including requestor 211, the ellipses 212 symbolically represent that there may be any number of requestors issuing file system commands to the file system restoration system 230. Furthermore, the file system commands issued by the requestors 210 are represented as a stream of file system commands 220 being received by the file system restoration system 230. The file system 231 may, but need not, be local to one or more or all of the requestors 210. For instances, one or more of the requestors 210 and the hierarchical system restoration system 230 may be located on the same computing system, such as the computing system 100 of FIG. 1. The file system commands 220 are illustrated as including two commands 221 and 222. However, the ellipses 223 represent that the file system restoration system 230 may receive any number of file system requests. Regardless, the file system command interception component intercepts at least some of the file system commands 220, and incrementally restores the hierarchy of the file system 232 in response to each of at least some of the file system commands 220.

Accordingly, restoration occurs little-by-little or incrementally. Nevertheless, even though the hierarchy of the file system 232 is not completely restored, and may only be even sparsely restored, the file system command interception component 231 intercedes to retrieve enough data from a remote store 240 (such as cloud computing environment) and populate that data into the file system 232 such that the file system 232 is able to provide the appearance of being fully restored by responding to the command as if the file system 232 was fully restored.

In one embodiment, this little-by-little or incremental restoration may be a just-in-time restoration system, in which only that data which is necessary to provide the illusion is restored. However, this is not necessary, as the principles described herein also anticipate embodiments in which the file system command interception component 231 anticipates possible future file system commands, and obtains data in advance to prepare for such file system commands.

For instance, in some cases, it is actually easier to restore more than less. As an extreme example, suppose a user was querying for just one attribute of a file. It might be seem faster to just query the attribute from the cloud, and apply just that attribute to the file. However, it could significantly complicate the functionality of the interception component 231 if that component had to keep track of which attributes had been restored for each file, thereby adding per-file state information. Such complexity could even slow down the latency in some respects in responding to such file system commands. Accordingly, it is best for the interception component 231 to have an appropriate balance between reducing state tracked by the interception component 231 and complexity of logic on the one hand, and providing adequate performance in terms of latency in responding to a file system command on the other hand. For a less extreme example, if the user is opening a specific child file in the directory, the interception component 231 might repopulate just that one file (and not any of its siblings) to make the open as fast as possible. But if the user were to then open the directory itself (for enumeration of all children), then the interception component 231 would repopulate all children files in the directory (so the underlying filesystem could enumerate the children)—excepting of course the file just opened. The latter case may be orders of magnitude slower (if there are hundreds or more files in the directory) than had the interception component simply repopulated the entire directory in response to the file open command.

FIG. 3 illustrates a flowchart of a method 300 for a hierarchical system command interception component to provide an appearance of a populated hierarchical system hierarchy even for a local hierarchical system having an incompletely populated hierarchy. The method 300 may be performed by the hierarchical system command interception component 231 of FIG. 2, each time it intercepts each of at least some of the hierarchical system commands 220. The method 300 is thus initiated when the hierarchical system command interception component 231 (e.g., the file system command interception component 231) receives a hierarchical system command (e.g., a file system command) directed towards the hierarchical system 232 (e.g., the file system 232) (act 301).

In response to intercepting the hierarchical system command (e.g., the file system command), the hierarchical system command interception component 231 (the file system command interception component 231) determines whether a compliant response to the hierarchical system command can be rendered by the hierarchical system based on a present population level of the local hierarchical system hierarchy 232 (e.g., the file system 232) (decision block 302). If the hierarchical population is sufficient (“Yes” in decision block 302) to render such a response, the hierarchical system command (e.g., the file system command) is passed to the hierarchical system 232 (e.g., the file system 232) (act 303) for normal processing. For instance, in the file system example, suppose that the file system command is to view the contents of a directory which is already populated with contents, read a file that is already present in its proper directory location, or write a file to a directory that exists in the already-restored file system hierarchy. In that case, the file system 232 can respond normally to the file system command.

In one embodiment, a file system hierarchy is considered sufficient to respond to a file read request, even if the file itself is sparsely populated. In that case, when the file system returns the sparse content of that file (all zeros), the interception component 231 might retrieve that content from the cloud or from an idempotent cache, without providing that content into the file system itself, and overlay that in the “read buffer” on top of the 0's that were returned from the underlying filesystem. This has two potential technical advantages. First, if the user has limited local space, they may want to keep that space reserved for “writes” (which have to be absorbed locally), rather than using up local file system space to service reads. Second, and more importantly, if there are multiple files (or multiple versions of the same file) that reference the same data, and the interception component 231 were to rewrite each of those files as they are read, the restoration system ends up with duplicate copies of the data in the local filesystem. To fix this second problem, the interception component might not actually read directly from the cloud into the user buffer, but rather from the cloud (based on fingerprint/injected function hash) into an idempotent cache described below. Then, if multiple files refer to it, those files remain sparse in the underlying file system, and there is just one copy of its content locally in the idempotent cache. This allows for continuous deduplication by only keeping one copy of a file locally, even though it may be referenced by multiple files. This same principle applies to deduplication on the directory level also.

However, if it is determined that there the hierarchical system hierarchy (e.g., the file system hierarchy) is insufficient to provide a visualized response (“No” in decision block 302), the hierarchical system command interception component 232 (e.g., the file system command interception component 232) identifies data (act 304) that would increase the hierarchical system 232 to a higher population level (e.g., with more directories, file, and/or metadata thereof) such that the hierarchical system 232 (e.g., the file system 232) could use that data to cause a proper visualization of a response to the hierarchical system command (e.g., a file system command). Nevertheless, because the restoration is incremental and synchronous in response to hierarchical system commands, the higher population level is still less than full population of the local hierarchical system hierarchy. This can be advantageous since the hierarchical system still appears fully operational without having to retrieve all of the hierarchy of the hierarchical system.

In this description and in the claims, the hierarchical system command interception component is described as intercepting a command in order to determine whether the hierarchical system can respond to the command. The hierarchical system command interception component 231 may have a concept of the hierarchical structure (e.g., the directory structure) of the hierarchical system 232 (e.g., the first system) in order to accurately make this determination. Alternatively of in addition, the interception component 231 may preliminarily pass the hierarchical system command to the hierarchical system 232 to see if an error results. If an error results, the interception component 231 may use information from that error to help identify what data is missing. The missing data is then obtained and used to repopulate the file system hierarchy, and the interception component 231 then asks the file system 232 to retry this file system command. In this description and in the claims, the “passing” of the command to the file system after populating the file system also refers to this retrying command.

The reason for “try first” and then “on failure, repopulate and retry” is that the full file system performance can be obtained this way for portions of the hierarchy that do not need repopulation or have already been repopulated. Accordingly, in one embodiment, for a file open command, if the file can be opened successfully, the interception component 231 need do nothing further. However, if an error occurs, the interception component 231 falls back (using slower code path) to see if the error might be because of incomplete file system population, and if so, query the cloud, repopulate, and retry. If the interception component 231 were always before every open to check if the hierarchy was fully populated in the neighborhood—by for example querying file attributes—that would actually slow down the open in the case where the filesystem was fully populated.

The hierarchical system command interception component 231 (the file system command interception component 231) retrieves the identified data from a remote store 240 (such as a cloud computing environment) (act 305). The hierarchical system 232 (e.g., the file system 232) is then populated with the retrieved data (act 306), and then the hierarchical system command (e.g., the file system command) is passed to the hierarchical system 232 (e.g., the file system 232), which can now properly respond to the hierarchical system command (e.g., the file system command).

The method 300 may be repeatedly performed responsive to successive hierarchical system commands to gradually increase the population of the hierarchy of the hierarchical system. For instance, in the file system example, as more and more file system commands are received, the directory structure and contents thereof of the file system become more and more populated. However, in many cases, there may be many portions of the directory structure or contents thereof that are never necessary to be restored to the file system hierarchy. Accordingly, this incremental synchronous method for restoring the file system is a much more efficient mechanism for restoration as the file system appears to be acting as normal, without having to utilize the enormous bandwidth and storage that would be required of a full restoration of the file system. File systems may be considered available even if there is nothing at all in the file system, expect perhaps a root directory.

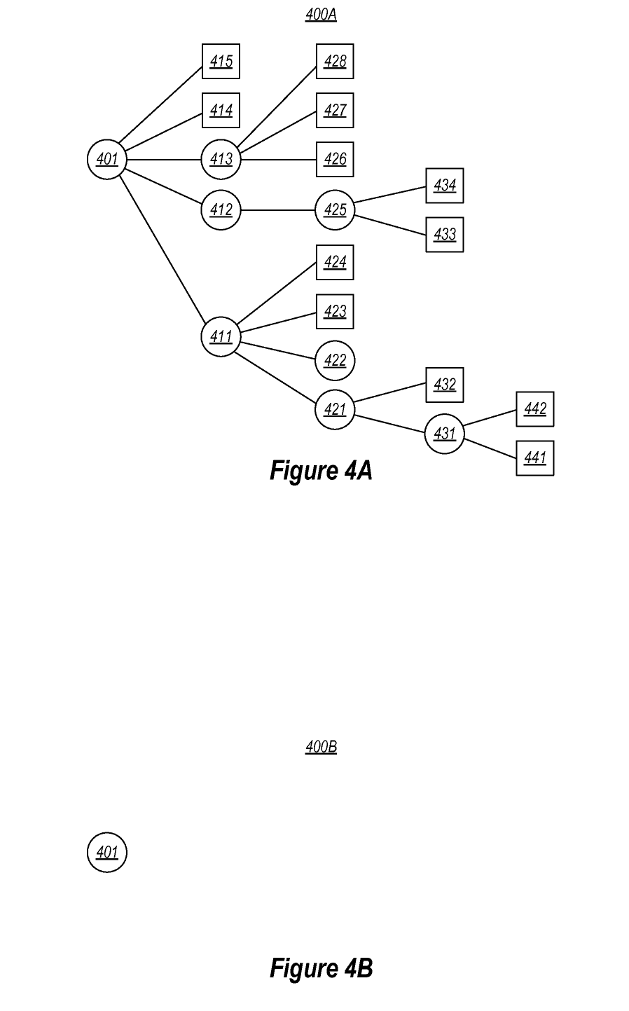

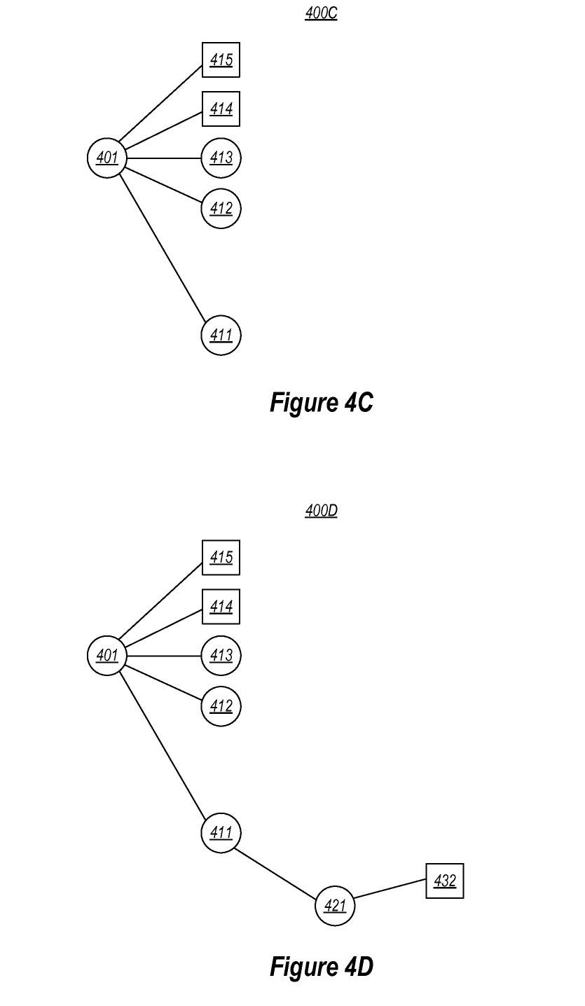

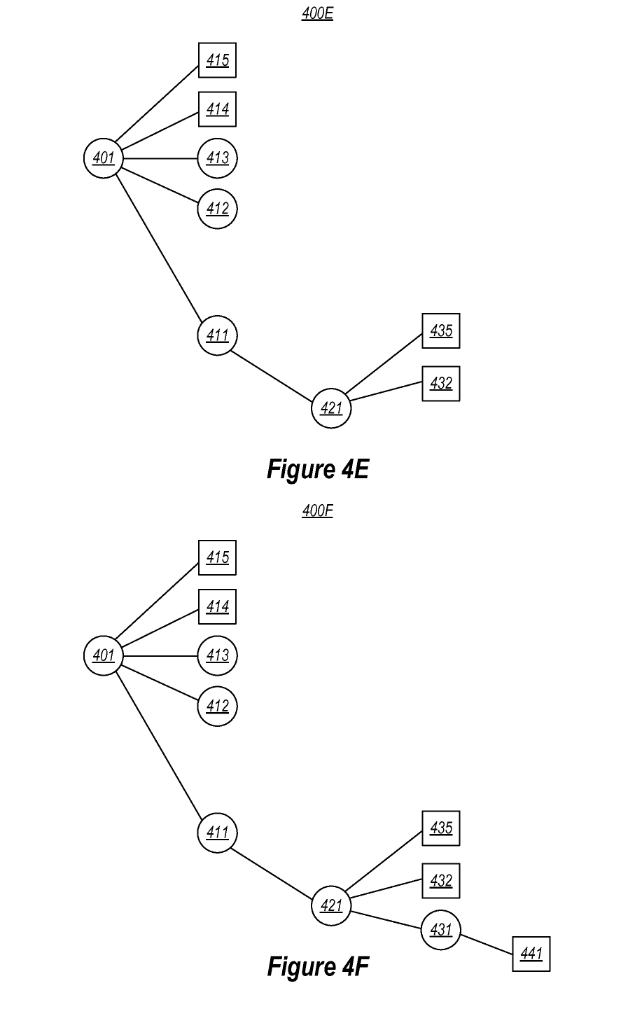

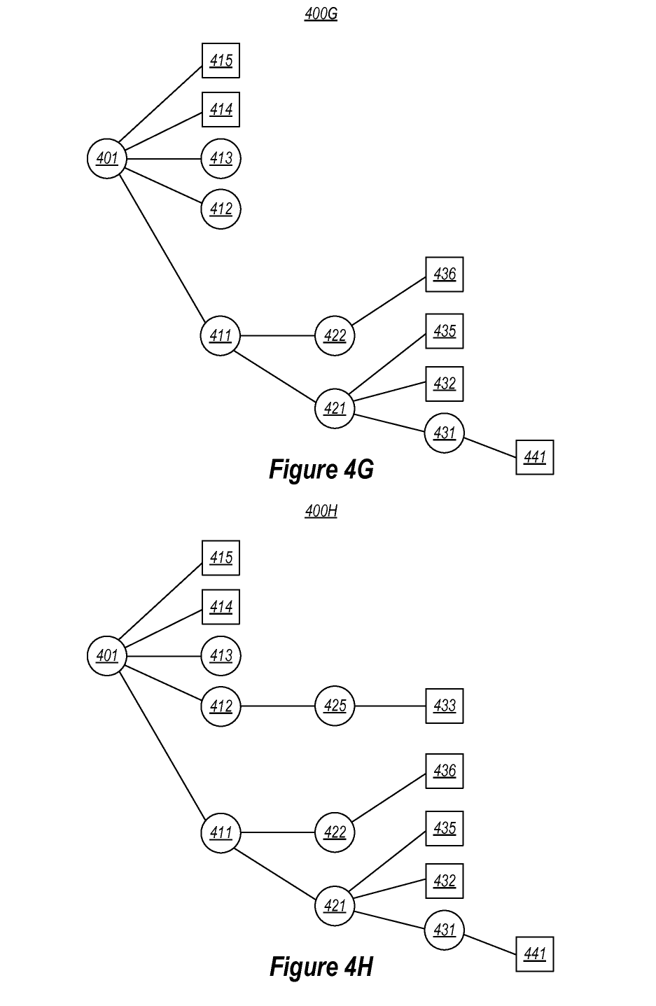

The method 300 of FIG. 3 will now be described with respect to a particular file system example that will be explained with respect to FIGS. 4A through 4H. Throughout FIGS. 4A through 4H, directories are symbolized with circles and files are represented by squares. In the example of FIGS. 4A through 4H, FIG. 4A represents the full extent of a file system hierarchy 400A of the file system if fully populated. For instance, in FIG. 4A, the file system hierarchy includes a root directory 401 that includes child directories 411 through 413 and files 414 through 415. Directory 411 has two child directories 421 and 422, and files 423 and 424. Directory 421 includes directory 431 and file 432. Directory 431 includes files 441 and 442. Directory 422 is empty of any files or directories. Directory 412 includes a single child directory 425 that includes two files 433 and 434. Directory 413 includes three files 426, 427 and 428.

As can be seen from FIG. 4A, the fully populated hierarchy 400A of this file system has numerous directories and files. The hierarchy 400A has some complexity and is used as the example herein, but the complexity thereof is dwarfed by the hierarchies of file systems presently in use in most file system hierarchies. Most file systems have more than a hundred nodes, and others may have millions of nodes. Furthermore, file systems are of such a nature that subdirectory and files can be added at almost any location. Any given file within a file system may be of any size, even gigabytes and sometimes terabytes in size. Accordingly, full restoration of such a file system can take considerable time, utilize considerable network bandwidth, and occupy significant storage and resources.

However, in accordance with the principles described herein, the file system may be operational and deemed restored (at least from the perspective of those components or entities submitting file system commands) even though the file system hierarchy itself is not fully populated. In fact, in a scenario described with respect to FIGS. 4B through 4H, the file system begins with simply a root directory.

For instance, FIG. 4B shows a sparsely represented hierarchy 400B of the hierarchy 400A, in which only the root directory 401 is present. That said, the principles described herein are not limited to a particular beginning population-level of the file system hierarchy. For instance, perhaps files and directories that allow the computing system that hosts the file system to boot may already be present. Alternatively or in addition, there may be a large file system that has a directory for each of multiple snapshots of a file system as that file system existed at a particular point in time. In that case, the root directory of each snapshot would essentially be the corresponding directory.

Returning to the example of FIGS. 4A through 4H, FIG. 4B shows that the file system hierarchy 400B begins with only the root directory 401. As is commonly known, file system nodes can be addressed via a file system path. More generally speaking, a hierarchical system node can be addressed via one or more paths. FIGS. 4B through 4H show how the file system hierarchy will be incrementally restored towards the file system hierarchy 401A without ever actually arriving at the file system hierarchy of FIG. 4A.

Now suppose a first file system command is issued, which is a directory command to enumerate the contents of the root directory 401. The issuance of this command (which is an instance of act 301) would commence the operations of the method 300 of FIG. 3. Proceeding through the method 300, the file system command interception component 231 would then determine that the present state of the file system hierarchy (of FIG. 4B) is insufficient for the file system to be able to enumerate the contents of the root directory 401 (“No” in decision block 302). After all, the root directory 401 of the file system hierarchy 400B in FIG. 4B has no contents, whereas a proper response would show the existence of subdirectories 411 through 413, and files 414 and 415 as in the case of FIG. 4A.

Accordingly, the file system command interception component 231 identifies the data that is to be retrieved from the remote store 240 in order for the file system 232 to be able to respond to the directory command in the same way as it would had the file system 232 contained the full file system hierarchy (act 304). In this case, the data would be at least a name of the subdirectories 411 through 413, a name of the files 414 and 415, and perhaps as much metadata regarding the same that would be needed to give the appearance that all of the subdirectories 411 through 413 and files 414 and 415 are present (even though some or even all of the actual contents of the subdirectories 411 through 413 and files 414 and 415 are perhaps not retrieved). For instance, the metadata might include the node size, last modified time or data, and so forth.

Next, the identified data is obtained from the remote store (act 405) to thereby further populate the file system hierarchy (act 406). For instance, in FIG. 2, the file system command interception component 231 may request data representing the names and metadata of the directories 411 through 413 and files 414 and 415 from the remote store 240. The names and metadata of the file system nodes 411 through 415 are then populated into the file system 232. The resulting file system hierarchy 400C is illustrated in FIG. 4C. Note that the file system hierarchy 400C represents an incremental restore of the file system hierarchy 400A.

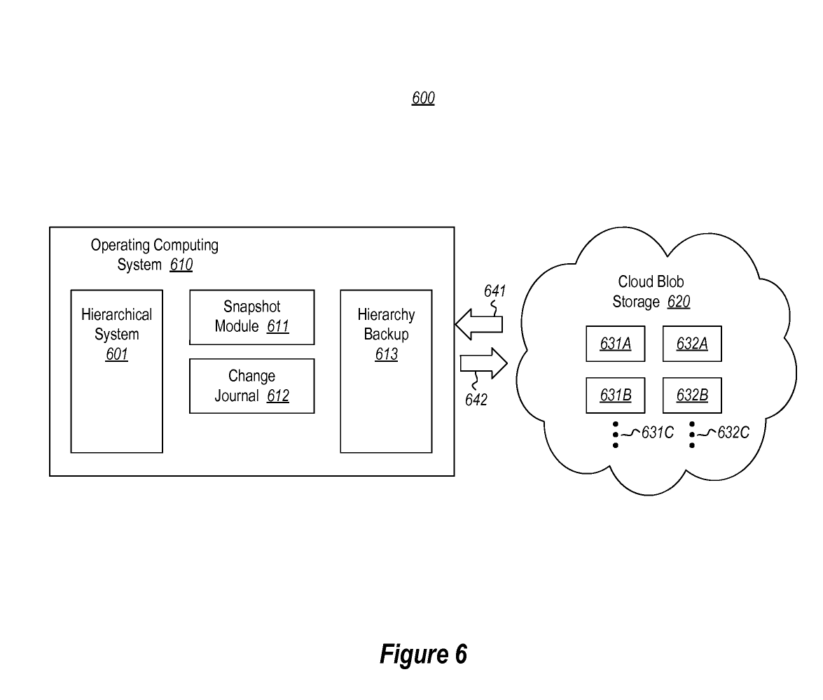

Then, the file system command (i.e., the directory command at this stage) is permitted to pass to the file system 232 (act 403). Now the file system 232 has enough information to be able to fully respond to the directory command, allowing the requestor to see an enumeration of the contents of the root directory 401. The experience may be quite identical to the experience had the requestor issued the same command in the context of the entire file system hierarchy 401A having being previously fully restored. Of course, there may be some latency associated with identifying the data to be retrieved, and retrieving the data to incrementally populate the file system hierarchy. However, as will be described with respect to FIG. 6 through 11, this latency may be significantly reduced by using collections of related injected representations.

Now suppose there is a read command issued for the file 415 (act 301), which initiates another performance of the method 300. In the case in which only the name and other metadata (such as file size—so that the read could address bytes of the file) of the file 415 had not been retrieved in the prior iteration of the method 300, then there is no content of the file 415 to be read. Accordingly, the file system command interception component 231 determines that the file system 232 cannot respond to the read command in the same manner as it would had the entire hierarchy 400A been previously full restored (again “No” in decision block 302). Accordingly, the file system command interception component 231 identifies the content of the file 415 (or at least the portion to be read) is to be retrieved (act 304), retrieves the identified content from the remote store (act 305), and populates the file 415 with that content (act 306). Then, the read command is permitted to pass through file system (act 303), whereupon the requestor is permitted to read the contents of the file 415, just as the requestor would be able to do had the entire file system hierarchy 400A been previously restored. Alternatively, as described above, the interception component 231 passes file read commands to the file system 232 without first writing the data to the file system 232, and then modifies the response with data populated from the cloud or from the idempotent cache.

Now suppose that the requestor edits the file 415, and thus a file update command is issued. The file system command interception component 231 intercepts this command (act 301) initiating another instance of the method 300. Here, the file system 232 can respond to that file update command (“Yes” in decision block 302), and the file update command is permitted to pass through to the file system 232 (act 303), whereupon the file 415 is updated. Again, the experience is the same as it would have been had the entire file system hierarchy 400A been previously fully restored.

Now suppose the requestor issues a file read command (act 301) specifying the path associated with file 432 (e.g., c:\dir411\dir421\file432.ext). This would again initiate operation of the method 300. However, although the metadata associated with the directory 411 has been retrieved, none of its contents have been retrieved. Accordingly, the file system command interception component 231 determines that the file system 232 cannot respond to such a file system command (“No” in decision block 302). Rather, the file system command interception component 231 identifies that the subdirectory 421 and the file 432 is to be retrieved (act 304). The file system command interception component 231 then retrieves this identified data (act 305), and the file system hierarchy is augmented (act 306). The resulting file system hierarchy 400D is illustrated in FIG. 4D. Note that the file system hierarchy 400D represents another incremental restore of the file system hierarchy 400A. Then, the read command is then permitted to pass through file system (act 303), whereupon the requestor is permitted to read the contents of the file 432, just as the requestor would be able to do had the entire file system hierarchy 400A been previously restored.

Now suppose that the requestor writes a new file 435 to the directory 421, and thus a new file command is issued. The file system command interception component 231 intercepts this command (act 301) initiating another instance of the method 300. Here, the file system 232 can respond to the new file command (“Yes” in decision block 302) because the directory 421 in which it is to be written already exists. Accordingly, the new file command is permitted to pass to the file system 232 (act 303), whereupon new file 435 is written to the directory 421. The resulting file system hierarchy 400E is illustrated in FIG. 4E. Although this operation is not technical a restore of the file system hierarchy 400A, it does demonstrate that the user can interface with the file system hierarchy (with both reads and writes) just as though the full file system hierarchy 400A had been previously restored, although it will be read command, and other commands that reveal previously existing structure (such as directory commands, and commands with path names) that result in incremental restore.

Now suppose the requestor issues a file read command (act 301) specifying the path associated with file 441 (e.g., c:\dir411\dir421\dir431\file441.ext). This would again initiate operation of the method 300. However, although the metadata associated with the directory 421 has been retrieved, none of its contents have been retrieved. Accordingly, the file system command interception component 231 determines that the file system 232 cannot respond to such a file system command (“No” in decision block 302). Rather, the file system command interception component 231 identifies that the subdirectory 431 and the file 441 is to be retrieved (act 304). The file system command interception component 231 then retrieves this identified data (act 305), and the file system hierarchy is augmented (act 306). The resulting file system hierarchy 400F is illustrated in FIG. 4F. Again, the file system hierarchy 400F represents another incremental restore of the file system hierarchy 400A, albeit with a new file 441 being added, and albeit with file 415 being updated.

Accordingly, the method 300 may be repeatedly performed in response to each file system command that requires additional restoration of the hierarchical system hierarchy in order to response. Thus, incremental synchronous restore results in incremental restore of the file system hierarchy, while simulating the presence of the full file system hierarchy, and while avoiding having to restore files and directories that are never accessed. The never accessed files may indeed account for a majority of the data associated with the full file system hierarchy. Furthermore, the file system may be considered substantially immediately restored by doing as little as simply establishing the parent directory of the file system.

The interception component 231 can also handle modifications to the depopulated directory. For instance, given the hierarchical state in FIG. 4F, suppose now that the interception component receives an instruction to add a new file 436 to the previously empty directory 422 (act 301) thereby initiating method 300 yet again. Well, empty directory 422 has not yet been restored, but its parent directory 411 has. Accordingly, the file system hierarchy is not sufficiently populated to allow the command to occur (“No” in decision block 302). Thus, the interception component 231 identifies that the empty directory 422 is to be obtained (act 304), retrieves the empty directory 422 (act 304), and populates the file system 232 of FIG. 4F with the empty directory 422 grafted into its parent directory (act 306). Now, the command to add the new file 436 to the empty directory 422 is passed to the file system (act 303). The file system 232 can now successfully respond by adding the new file 436 to the directory 422 to result in the file system hierarchy 400G illustrated in FIG. 4G.

As one final change, suppose that file 434 is now to be deleted from the directory 425 (act 301). This receipt of this command results in another performance of the method 300. Again, the directory 425 is not populated into the hierarchy 400G of FIG. 4G (“No” in decision block 302). It is determined that the directory 425 should be retrieved, along with all of its children (file 433 and 434) (act 304). This data is retrieved (act 305), and populated into the file system hierarchy (act 306). The command to delete file 434 is then permitted to pass to the file system (act 303) resulting in the file 434 being deleted. The resulting hierarchy 400H is illustrated in FIG. 4H.

Note that for some file system command, a hierarchical path is provided. Furthermore, a portion of the hierarchical path is then restored into the file system hierarchy thereby augmenting the file system hierarchy. For instance, this grafting process is described above with respect to the transition from FIG. 4C to FIG. 4D, with another example being with respect to the transition from FIG. 4E to FIG. 4F.

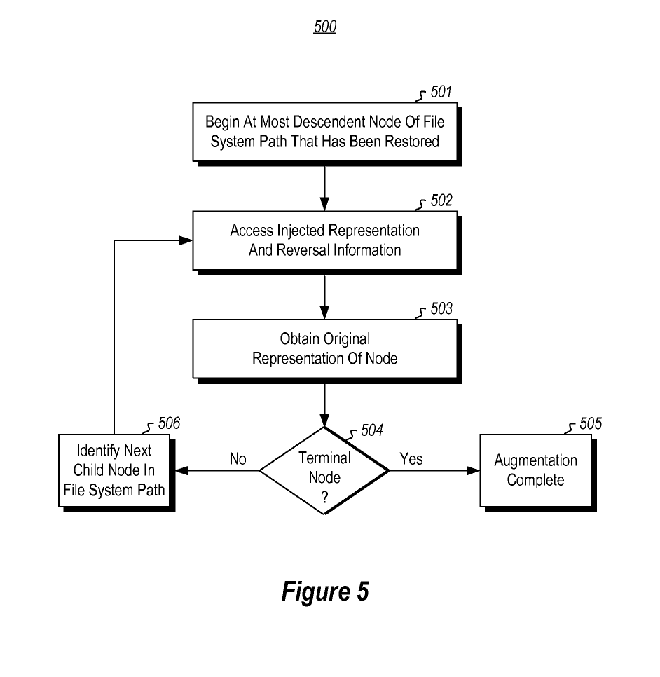

FIG. 5 illustrates a flowchart of a method for augmenting a file system hierarchy using the file system path. The method 500 begins at the most descendent node that currently exists in the file system hierarchy in the file system path (act 501). The interception component 231 then uses the identification of the corresponding node to access an injected representation of the corresponding node and reversal information of the corresponding node (act 502). More regarding this injected representation and reversal information will be described with respect to FIGS. 6 through 11.

The interception component 231 then uses the reversal information to obtain the original representation of the corresponding node (act 503). If the original representation is the terminal node in the file system path (e.g., a file) (“Yes” in decision block 504), then the augmentation of the file system hierarchy based on the file system path is completed (act 505). However, if the original representation is not the original representation is not the terminal node in the file system path (“No” in decision block 504), then the original representation includes an identification of one or more child nodes of the corresponding node, including the next descendent node in the file system path. In that case, the next node in the file system path is identified (act 506), and the process repeats from act 502 for the next node.

If the data of the file system is represented in the remote storage 240 in a certain way, the process of retrieving that data, and augmenting the hierarchical system hierarchy may be particularly efficient, thereby reducing the latency introduced by have the interception component 231 access the data from the remote storage 240 and thereafter augment the hierarchical system 232. Accordingly, there is less of an impact on the user as a result of the incremental synchronous restore discussed above. Accordingly, FIGS. 6 through 11, and the accompanying description thereof, will illustrate how the data may be represented in this fashion.

FIG. 6 illustrates a hierarchical system backup environment 600 in accordance with one embodiment of the principles described herein. The hierarchical system backup environment 600 includes an operating computing system 610 on which a hierarchical system 601 is operating. As an example, the operating computing system 610 may be structured as described above for the computing system 100 of FIG. 1. The hierarchical system backup environment 600 also includes cloud blob storage 620 to which the hierarchical system 601 is to be backed up. For instance, the cloud blob storage 620 of FIG. 6 may be an example of the remote store 240 of FIG. 2. Furthermore, the hierarchical system 601 of FIG. 6 may be an example of the hierarchical system 232 of FIG. 2.

The “cloud blob” storage is a term of art that describes a particular type of cloud storage in which stored data is primarily described by name, and is persisted primarily in binary format. Thus, cloud blob storage allows users to store binary objects (or “blobs”) in a cloud environment. In accordance with the principles described herein, each node of the hierarchical system, including the entirety of the hierarchical system, may be represented by a corresponding blob.

The operating computing system 610 also includes a snapshot module 611, a change journal module 612 and a hierarchy backup manager 613. In this description and in the claims, the term “computing system” is defined broadly as including any computing system device or a distributed collection of collaborating computing systems. Accordingly, while some or all of the snapshot module 611, the change journal 612, and the hierarchy backup manager 613 may be located on the same physical system as the hierarchical system 601, that need not be the case. Furthermore, even the hierarchical system 601 itself may be distributed.

The principles described herein allow hierarchical systems (such as file systems or database systems) to be backed up and restored efficiently. With such efficient restore, the latency associated with incremental synchronous restore described above may be significantly reduced. Essentially, each of the nodes of the hierarchical system, including the root directory, may be represented as an injected representation of the combination of an attribute (e.g., a name) of the node as well as the content of that node.

In order to define the term “injected representation”, this description will first discuss the characteristics of an “injective function”. An injective function is a function that preserves distinctness between an input domain and an output domain. In other words, for any possible input content from the input domain, there is but one possible output in the output domain, and no other distinct content from the input domain can generate the same output in the output domain. Using mathematical symbols, let f be a function whose domain is a set A. The function f is injective if and only if for all a and b in A, if f(a)=f(b), then a=b. Equivalently, if a does not equal b, then f(a)≠f(b).

In this description and in the claims, a “statistically injective” function is a function that in which for all a and b in A, if f(a)=f(b), then with high probability a=b. High probability may be selected from the group consisting of 1) a virtually impossibility, 2) so improbable that even with a million selections of “a” and a million selections of “b” in domain A it is less likely than otherwise that there exists any selected “a” and any selected “b” such that f(a)=f(b), 3) so improbable that even with a billion selections of “a” and a billion selections of “b” in domain A it is less likely than otherwise that there exists any selected “a” and any selected “b” such that f(a)=f(b), 4) so improbable that even with a trillion selections of “a” and a trillion selections of “b” in domain A it is less likely than otherwise that there exists any selected “a” and any selected “b” such that f(a)=f(b), 5) any value less than or equal to 1⁻¹²⁸, or 6) any value less than or equal to 2⁻²⁵⁶.

For instance, consider a SHA-256 hashing algorithm. There are 2²⁵⁶ (on the order of 10⁷⁷) possible unique output values of such an algorithm. For scale, some estimates have the number of atoms in the observable universe to be on the order of from 10⁷⁸ to 10⁸². Accordingly, the chance of two distinct values resulting in the same output value of a SHA-256 hashing algorithm is on the order of the chance that an atom might be selected at random from all of the atoms in the observable universe, and then upon re-performing the same random selection, finding that the same atom has again been selected. Such can be considered a virtual impossibility. In fact, even if this process is repeated a quadrillion (10¹⁵) times to select a quadrillion atoms, the chance of any of those two atoms being the same remains a virtual impossibility, even considering the birthday paradox. Accordingly, a SHA-256 hashing algorithm may be considered a statistically injective function as the term is defined herein. Accordingly, in this description and in the claims, a “statistically injective function” may also be simply termed an “injective function”. In this description and in the claims, an “injected representation” of particular content means a result of performing a statistically injective function on the particular content.

Note that exact perfection in the injective function is not required as the system may already have imperfections already. Accordingly, the statistical certainty in the injective function is sufficient such that any uncertainty is negligible given the small amount of uncertainty already present in any complex system.

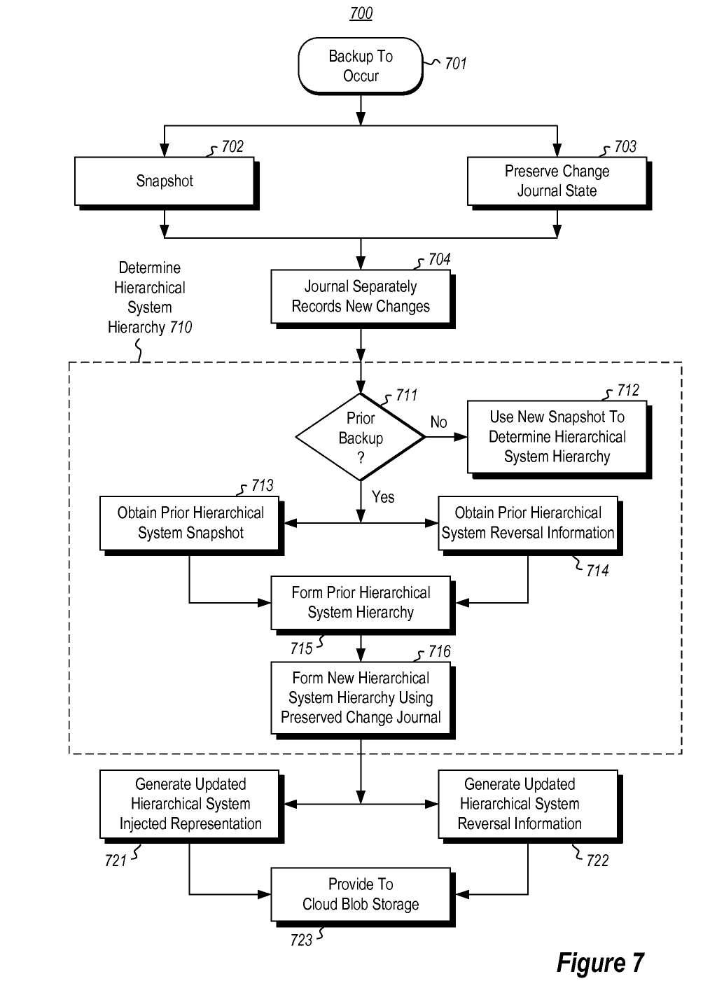

FIG. 7 illustrates a flowchart of a method 700 for backing up a hierarchical system. Optionally, the method 700 may be performed in the backup environment 600 of FIG. 6. Accordingly, the method 700 will now be described with frequent reference to the backup environment 600 of FIG. 6. The method 700 is performed in the context in which the snapshot module 611 has taken a previous snapshot of the file system, and the change journal 612 has tracked at least some changes that have been imposed on the hierarchical system since the previous snapshot. However, variations of the method 700 may be performed even when there has been no prior snapshot of the hierarchical system 601 taken. Such variations will also be described further below.

The hierarchy backup manager 613 performs the work of backing up in response to a determination that the hierarchical system 601 is to be backed up (act 701). The principles described herein are not limited to any mechanism or policy for how the hierarchy backup manager 613 makes this determination to back up the hierarchical system 601. Typical back up policies may be responsive to detection of certain events, the passage of an interval of time since the last backup, combinations thereof, and so forth. However, since the principles described herein allow backup of the hierarchical system (or portions thereof) to be efficiently performed (perhaps on the order of mere minutes, seconds or fractions of a second), backup might be more frequently than conventional hierarchical system backup systems might normally allow. In some embodiments, the hierarchical system backup might occur as often as a hierarchical is saved (either explicitly by the user, or through auto-saving operation) after editing. This may also be thought of as checking in the changes to a source control system.

As part of the backup operation, the snapshot module 611 may take a snapshot (act 702) of the hierarchical system as it exists at the time that the backup was determined to initiate. The determination that the backup is to occur (act 701) also triggers the change journal to preserve its state as it existed as of the time of the new snapshot (act 703). This state represents changes that have occurred until the point of the new snapshot since a prior snapshot of the hierarchical system. After the new snapshot is taken (act 702) and the change journal is preserved (act 703), the change journal begins recording new changes (act 704) that have occurred since the new snapshot was taken. The new changes may be used for a subsequent backup when the method 700 is performed on a future backup iteration.

The hierarchy backup manager 613 determines a state of the hierarchical system hierarchy (act 710) as it exists at the time the backup snapshot was taken (in act 702). If there has been no prior backup of the hierarchical system 601 taken (“No” in decision block 711), then perhaps the snapshot (taken in act 702) may be used directly (act 712) to determine the hierarchical system hierarchy. Alternatively, perhaps the hierarchy backup manager 613 has constant awareness of the hierarchical system hierarchy at any point in time by tracking directory and file creation, deletions, and modifications.

On the other hand, if there has been a prior backup of the hierarchical system 601 taken (“Yes” in decision block 711), then a prior injected hierarchical system representation of the hierarchical system corresponding to the prior hierarchical system snapshot is obtained (act 713). Also, the prior file system reversal information corresponding to the prior file system snapshot is obtained (act 714).

Referring to FIG. 6, the prior injected representation 631A of the hierarchical system and the prior hierarchical system reversal information 632A are illustrated as having been stored in the cloud blob storage 620. Furthermore, the operating computing system 610 accessing of the prior injected hierarchical system representation 631A and the prior hierarchical system reversal information 632A is represented by arrow 641. This information may not need to be retrieved from the cloud. One optimization is to more efficiently retrieve this information from a cache of certain injected representations (and associated reversal information) recently written to (or read from) the cloud. These injective representations (and containing reversal information) are by definition idempotent without risk of coherency issues or currency. Thus, if an injective representation is in the cache, the injective representation can be used with no risk of it being incorrect. This cache is referred to as the idempotent cache above.

As will be seen from the description below, generation of the injected hierarchical system representation and the hierarchical system reversal information occur as the result of the backup method 700. Accordingly, the prior injected hierarchical system representation 631A and the prior hierarchical system reversal information 632A were generated and stored in the cloud blob storage 620 via a prior exercise of the method 700.

The hierarchy backup manager 613 then formulates a hierarchical system hierarchy as that hierarchical system existed in the prior hierarchical system snapshot (act 715) using the prior injected hierarchical system representation 631 and the prior hierarchical system reversal information 632. Details regarding how this might be done will be described further below. However, recall that the injected hierarchical system representation 631 is a distinct one-to-one function (i.e., an injective function result) of the prior state of the hierarchical system. The hierarchical system reversal information is any information that would allow the reverse of the injective function to be performed on the injected representation of the hierarchical system to thereby again retrieve the prior content of the hierarchical system. At this point, however, only the hierarchical system hierarchy is formulated (e.g., the directory structure with the names of the directories and the names of the files representing leaf nodes of the file system hierarchy).

The hierarchy backup manager 613 then formulates a changed hierarchical system hierarchy (act 716) using those changes between the prior snapshot and the current snapshot. Recall that those changes were captured as of the current snapshot time in act 703. Those changes are then fed to the hierarchy backup manager 613. Basically, the process starts at the leaf nodes of the lowest level directories, recompute the injected representations, and then the higher level injected representations of their parent node can be determined. Then the analysis move up to the next lower level of nodes, and incorporate new injective representations as well as the new injective representations computed at the previous lower level. Then we move up to the next higher level, and so on. So the order that changes are applied is arbitrary within a given level, and “lowest to highest” between levels. For this same reason, the change journal need not even record changes chronologically.

If a journal entry indicates that leaf node has been altered, then that leaf node is invalidated, meaning that that leaf node is marked as requiring backup. If a journal entry indicates that a leaf node is added, then that leaf node is also marked as to be backed up. If a file or directory is deleted, then that deletion is also marked as to be reflected in the backup. Any of these operations also result in change in the content of any of the nodes in the ancestral chain of the affected leaf node. Accordingly, in order to capture the current state of those directories in the ancestral chain, the content of those directories is backed up. However, due to the principles described herein, the backing up of such directories is not computationally intensive, does not require significant bandwidth between the operating computing system 610 and the cloud blob storage 620, and does not require significant amounts of storage space within the cloud blob storage 620. In an alternative embodiment, the change journal is not used to detect node additions, deletions or renames. Instead, the hierarchical structure is traversed (without examining the content itself) in both the previous and current backup. Node identifiers are then used to preserve when a leaf node is renamed and are never reused, to determine which leaf node are new and which are old and which are renamed, moving from one backup to the next. This is equivalent to using a perfect change journal to record leaf node additions, deletions, and renames. However, this alternative embodiment does avoid some race conditions that exist when a leaf node is renamed multiple times between backups, and allows the change journal to be avoiding needing to record changes chronologically.

At this point, regardless of whether the hierarchical system backup is being performed for the first time (“No” in decision block 711), or is just an updated hierarchical system backup (“Yes” in decision block 712), the updated hierarchical system hierarchy has been formulated (act 712 or act 716). In either case, the hierarchy backup manager 613 generates an updated injected representation of the hierarchical system (act 721) by applying a statistically injective function to the hierarchical system content. While this might seem like an onerous and processing intensive task, using the principles described further below, this formulation of the updated injected file system representation may be performed rapidly and efficiently, especially when the file system has already been previously backed up for prior states. The compute of the injective function need not be performed (whether at the leaf node or any other node) if that node has not changed, since it was previously determined and cannot have changed. The hierarchy backup manager 613 also formulates (act 722) updated hierarchical system reversal information using the changed hierarchical system hierarchy.

The hierarchy backup manager 613 then causes the updated injected hierarchical system representation and the updated hierarchical system reversal information to be provided to the cloud blob storage 620 (act 723). For instance, in FIG. 6, the operating computing system 610 providing of the updated injected hierarchical system representation 631B and the updated hierarchical system reversal information 632B is represented by arrow 642. After this providing (represented by arrow 642), the updated injected hierarchical system representation 631B and the updated hierarchical system reversal information 632B are illustrated as being stored in the cloud blob storage 620.

Note that this method 700 may be repeated for each backup of the hierarchical system. In the next backup of the hierarchical system, the updated injected hierarchical system representation 631B and the updated hierarchical system reversal information 632B would play the role of the prior injected file system representation 631A and the prior hierarchical system reversal information 632A, respectively. Furthermore, the changes from the change journal would reference changes since the new backup, as opposed to the prior backup. Thus, the ellipses 631C represent that there may be multiple versions of injected hierarchical system representations of the hierarchical system 601 within the cloud blob storage 620. Likewise, the ellipses 632C represent that there may be multiple versions of hierarchical system reversal information within the cloud blob storage 620, each allowing recover to a different backed up version.

As previously mentioned, the hierarchy backup manager formulates an injective hierarchical system representation (act 721) and a hierarchical system reversal information (act 722) for the entire state of the hierarchical system as it existed at the time of the backup time. In one embodiment, in order to do so, the hierarchy backup manager formulates an injective hierarchical system representation for each node within the hierarchical system. Rather than perform the statistically injective function (e.g., the SHA-256 hash) on the entire contents at each level in the file system hierarchy, the hierarchy backup manager begins at the lowest leaf nodes in the hierarchical system hierarchy, and uses injected representations of child nodes in a particular directory in order to more quickly formulate the injected representation of the parent node.

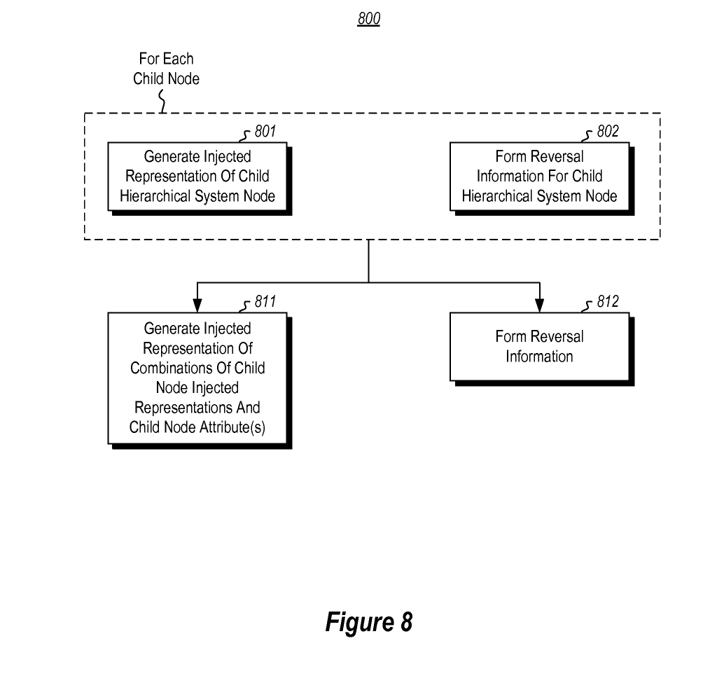

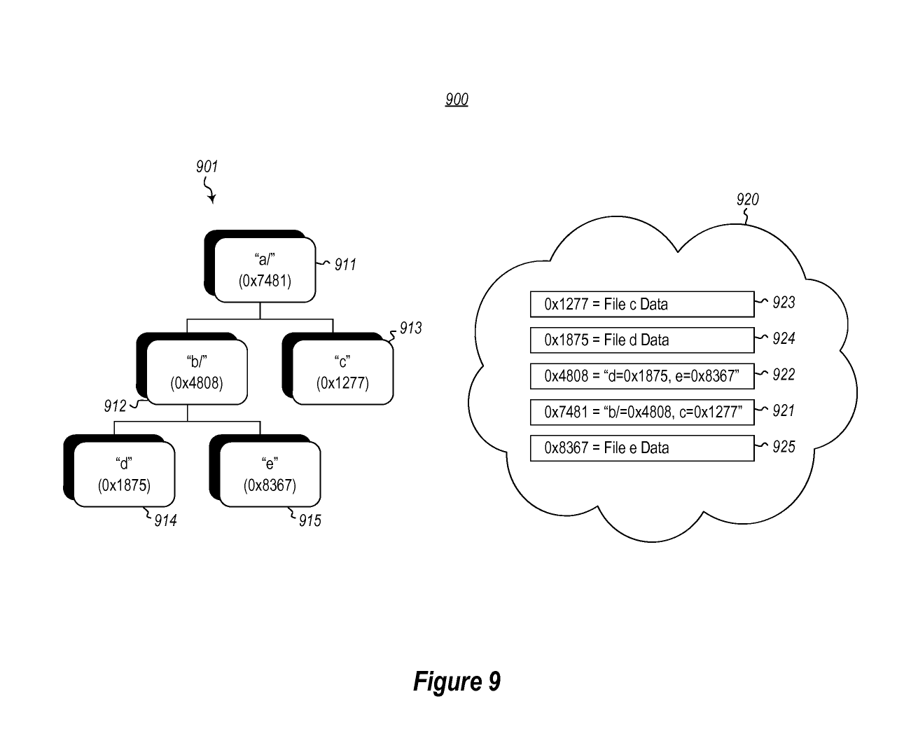

FIG. 8 illustrates a method 800 for formulating an injected representation of a parent node (e.g., a directory) in the hierarchical system, which method may be recursively repeated for each non-leaf node in the file system hierarchy. FIG. 9 illustrates an example environment 900 that shows an example hierarchical system hierarchy in the form of a file system hierarchy 901 being backed up into the cloud blob storage 920. Accordingly, the method 800 will now be described with frequent reference to the example environment 800. The example file system hierarchy 801 is simple for clarity in describing the principles described herein. However, the principles described herein are not limited to the structure or complexity of the file system hierarchy. Some file system hierarchies may have many thousands or even millions of nodes (i.e., directories or files).

Since hashing is an effective mechanism for performing a statistically injective function, the performance of the statistically injective function will be hereinafter sometimes be referred to as “hashing”, and the injected representation of content will be hereinafter sometimes be referred to as a “hashed” representation. In the illustrated example of FIG. 9, the hashed representation is a SHA-256 hash.

Assume for now, that this is the first time that the file system hierarchy 901 has been backed up. Before performing the method 800 for each non-leaf node, the hashes for each of the leaf nodes are obtained. More generally stated, a hash for a given node cannot be determined until the hashes for all of its child nodes are known, thus leading to bottom up hashing through the hierarchy. Typically, leaf nodes in a file system hierarchy are files, except in the unique case of an empty directory. In the example file system hierarchy 901, there are three leaf node files 913, 914, 915 called by names “c”, “d”, and “e”, respectively.

Since the method 800 is performed recursively from bottom to top, the method 800 would first be performed with respect to the directory 912 (named “b”) in order to obtain an injected representation of directory “b”. Thus, directory “b” is the “parent directory” in this recursive iteration of the method 800.

According to method 800, for each child node of the parent directory “b”, a statistically injective function (e.g., a hash) is performed (act 801) on the child node to obtain the injected representation (e.g., a hash of) the child node. Thus, the content of file “d” is hashed to obtain hashed result 0x1875, and the content of file “e” is hashed to obtain hashed result 0x8367. In addition, reversal information usable to reverse the injected representation back into the original content is formulated (act 902). The reversal information may be generated in a similar process as the injected representation is formed.

In one embodiment, in order to hash files, a distinction is made between small files and larger files. For instance, for small files, the file hash might be exactly the hash of the file contents. However, for larger files, those files may be divided into portions, which may be addressed by a page table. For rather larger files, the page table might have several levels. In this case, the file hash may be the hash of the top-level page table. The top-level page table contains the hashes of the pages of the next lower-level page table, and so on. In this way, larger files are processed one portion at a time, and the page table hierarchy logically lives below the file system hierarchy. For instance, if referring to FIG. 9, suppose file “e” is a large file. The hash value 0x8367 may have been obtained by the hashing of the top level in the page table. Thus, child node 915 may be thought of as representing a page table tree that is grafted into the file system hierarchy at that same point. In this case, to accomplish the grafting, the content of the injective representation at the point of the graph would represent that the node points to a page table. There is a similar flag for the other nodes that indicates whether the node is an intermediate node (such as a directory), a leaf node (such as a file), a single level page table, or a multiple level page table (along with the number of levels).

Once the hash for all of the child nodes is obtained, a statistically injection function is performed on each child injected representation (e.g., each child hash) along with at least attribute of that child node (e.g., a file system name whose representation is to be preserved in the cloud) (act 811). For instance, in FIG. 9, the hierarchy backup manager might perform a hash of the following string “d=0x1875,e=0x8367”, which string included the hashes of files “d” and “e” as well as the files' corresponding names. In this case, the resulting hash for directory “b” is 0x4808. Accordingly, now there is an injected representation of directory “b”. Furthermore, reversal information usable to retrieve the injected representation of each child node and its attribute is formulated (act 812). For instance, that reversal information may be used to obtain the string “d=0x1875,e=0x8367” given the input 0x4808. In addition to the name of the node, other metadata may also be provided (such as size, or file type) to allow a sparse version of the child node to be represented to simulate restoration of the full file system hierarchy 400A.

The recursion then may move forward one iteration to be applied to the root directory “a” of the file system. Thus, directory “a” is the “parent directory” in this next recursive iteration of the method 800.

According to method 800, for each child node of the parent directory “a”, a statistically injective function is performed (act 801) on the child node to obtain the injected representation the child node. Thus, the injected representation of directory “b” is to be obtained. However, recall that the injected representation (0x7481) of directory “b” has been obtained by the prior iteration of the method 800, hence the recursion. Accordingly, file “c” is hashed to obtain its injected representation 0x1277. In addition, reversal information usable to reverse the injected representation back into the original content is formulated (act 802).

Then, a statistically injection function is performed on each child injected representation along with at least attribute of that child node (e.g., the name) (act 811). For instance, in FIG. 9, the hierarchy backup manager might perform a hash of the following string “b/=0x4808,c=0x1277”, which string included the injected representation of directory “b” obtained in the prior iteration of the method 800, as well as the hash of file “c”, and as well as the child directory's and file's corresponding names. In this case, the resulting hash for directory “a” is 0x7481. Accordingly, now there is an injected representation of the root directory “a”. Furthermore, reversal information usable to retrieve the injected representation of each child node and its attribute is formulated (act 812). For instance, that reversal information may be used to obtain the string “b/=0x4808,c=0x1277” given the input 0x7481.

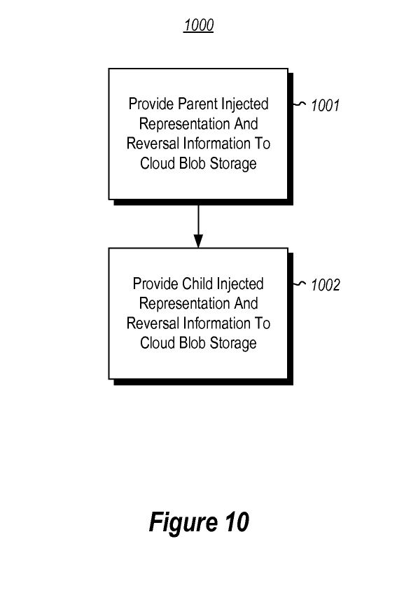

In accordance with act 723, the injected representations for each of at least some of the file system nodes may be provided to the cloud blob storage. FIG. 10 illustrates a method 1000 for providing the injected representations for file system nodes into the cloud blob storage. Although not required, the method 1000 might be performed recursively from the top of the file system hierarchy down to the leaf nodes of the file system hierarchy. Accordingly, in those embodiments, the hash for a given file system node is not provided to the cloud blob storage until the hash for the parent node is provided to the cloud blob storage. This might be helpful in situations in which the cloud blob storage garbage collects by determining if an injected representation is referred to by another injected representation. If the hash of the child node was provided first, before the hash of the parent node, this could result in such a garbage collection algorithm adjudicating the child hash as no longer referenced, and to be marked for disposal.

Accordingly, the method 1000 is first performed beginning at the root directory “a” being the “parent” directory. First, the parent injected representation (e.g., the hash 0x7481 of directory “a”) (and associated reversal information) is provided to the cloud blob storage (act 1001) to formulate entry 921 in cloud blob storage 920. Then all of the child injected representations (e.g., the hash 0x4804 of directory b/ and the hash 0x1277 of file c) (and the associated reversal information) is provided to the cloud blob storage (act 1002). For instance, act 1002 might result in entry 922 and 923 in the cloud blob storage 920, along with their reversal information.

The method 1000 is then again performed with respect to directory “b” being the parent directory. Of course, the hash 0x4808 of directory b and its reversal information have already been persisted in cloud blob storage (see entry 922). Accordingly, the method 1000 proceeds directly to act 1002 for child nodes “d” and “e”. Thus, the hash 0x1875 for file “d” and the hash 0x8367 for file “e” are persisted in the cloud blob storage along with their reversal information (act 1002). For instance, act 1002 might result in entry 924 and 925 in the cloud blob storage 920.

This above description constitutes details for how the file system may be backed up initially. However, once the file system is initially backed up, there will be further updates to the contents of the file system directory. For instance, whenever a directory is added or deleted, and whenever a file is created, updated, or deleted, the contents of the file system change.

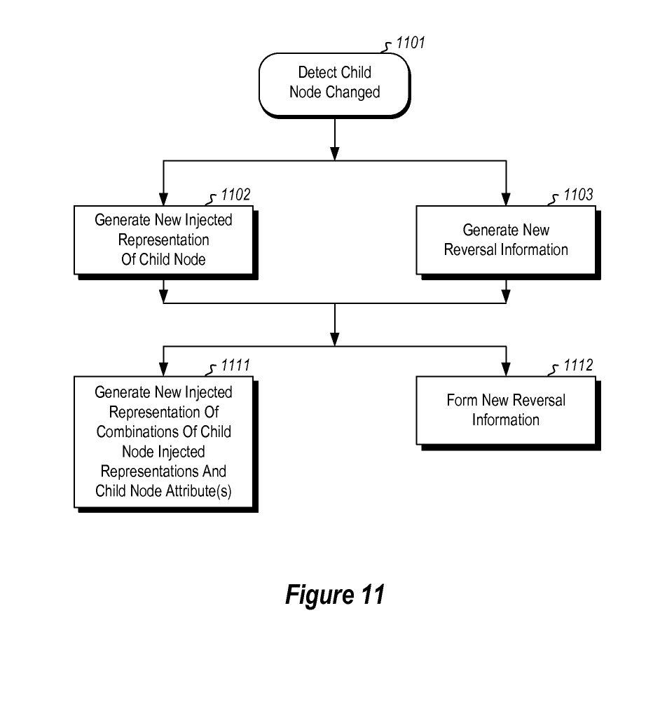

FIG. 11 illustrates a flowchart of a method 1100 for updating content of a parent directory in response to a change in a child node. The method 1100 may be performed recursively beginning at the node that was initially changed, all the way up to the root directory of the file system. This is done bottom to top in the hierarchy

Referring to FIG. 9, in a particular example, file “c” has been edited. Of course, the content of file “c” has thus changed, and the hash “0x1277” is no longer an injected representation of the updated file “c”. Likewise, any directory in the ancestral chain of file “c” leading all the way up to the root directory has also had its content changed. Accordingly, those injected representations are also no longer valid.

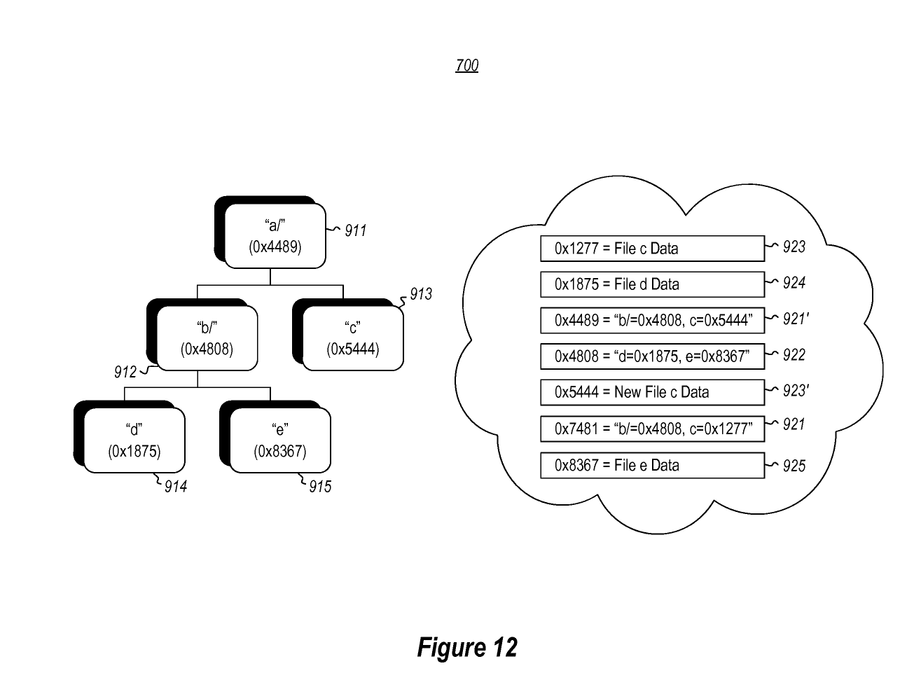

FIG. 12 illustrates a modified environment 1200 that represents a modification of the environment 900 of FIG. 9. The method 1100 will now be described with respect to the original environment 900 of FIG. 9 and the modified environment 1200 of FIG. 12.

The method 1100 is triggered upon detecting that a child node in a particular parent directory has changed (act 1101). In the first instance of method 1100, the method detects that the file “c” has changed. Accordingly, in this first instance of the method 1100, the file “c” is the “child node” and the root directory “a/” is the parent directory.

Upon detecting the update of the content of the child node (file “c”), a statistically injective function is performed on the revised content of the child node of the file system to formulate a revised child injected representation (act 1102) of the child node, as well as revised child reversal information (act 1103) usable to reverse the revised child injected representation back into the revised content of the child node. Acts 1102 and 1103 may be considered to be simply the same as acts 801 and 802, respectively, but performed with respect to the revised content of the child node, and only performed with respect to that child node (rather than all child nodes of the parent directory).

For instance, in FIG. 12, the content of file “c” is hashed to obtain a new hash 0x5444. If file “c” were a large file represented by a page table hierarchy, the method 1100 actually first be performed at the leaf node of the page table. Then, the method 1100 would be recursively performed until it hashes the parent node in the page table tree. Note that the injected representation and reversal information for nodes 912, 914 and 915 do not require recalculation.

The statistically injective function is then re-performed on the revised child injected representation and an attribute of the revised child node to formulate a revised parent injected representation of the parent directory (act 1111), and revised parent reversal information (act 1112) usable to reverse the parent representation of the directory into the revised child injected representation and the attribute of the revised child node. Acts 1111 and 1112 may be considered to be simply the same as acts 811 and 812, respectively, but performed using also the changed injected representation of child node 913. In FIG. 12, for example, the string “b/=0x4808,c=0x5444” is hashed to obtain the new injected representation 0x4489 of the root directory “a”. If the directory “a” were not the root directory, the method 1100 may be recursively performed so that that injected representations and reversal information is reformulated for each node beginning from the file (or from the file portion) all the way up the ancestral chain of the file system hierarchy (and potentially also the page table hierarchy) to the root directory.

The method 1200 may then be re-performed recursively to update those change nodes into the cloud blob storage. For instance, the entry 921′ for the root directory “a/” might first be created in the cloud blob storage, followed by the entry 923′ for the changed file “c”. Note that the prior entry 921 for the root directory “a/” and the prior entry 923 for the file “c” still remain in the cloud blob storage. This may be done because the hashes themselves (and associated reversal information) are relatively small, especially compared to cloud blob storage capabilities. Also, this allows the file system change to be easily undone, by simply reverting back to the prior entries 921 and 923. This also allows easy versioning of the file system by timestamping and version marking each entry.

The above describes the backing up of a file system in a manner that preserves versioning. However, the reverse process of the backup operation may be performed to restore content. For instance, suppose that file “c” was somehow lost on the operating computing system 610, or was otherwise to be retrieved as part of the above-described incremental restore operations. The hierarchy backup manager 613 may thus retrieve the entry 923 (or 923′ if restoring to the updated version), and use the reversal information to reformulate the content of file “c” from the injected representation of the file “c”. This would represent one performance of acts 502 through 505 of the method 500 of FIG. 5. The hierarchy backup manager 613 might have also begun by retrieving the entry 921 (or 921′ if restoring to the updated version), and used the reversal information to thereby recovered the string “b/=0x4808,c=x5444). In order to do this, there would also be some identification of the path of interest to arrive at the file. This gives the child injected representation of file “c”, from which (using also the reversal information for file “c”), the content of file “c” may be restored. This may also involve performance of the method 500 described above with respect to FIG. 5.

Accordingly, the principles described herein provide an efficient mechanism for performing synchronous incremental restore of a file system such that incremental buildup of the file system occurs in relative real-time, thereby preserving the illusion that the file system hierarchy has been fully restored. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An incremental synchronous hierarchical system restoration system comprising:
a hierarchical system command interception component that is structured to respond to hierarchical system commands issued to a hierarchical system that has an incompletely populated hierarchy by performing the following:
an act of determining that a visualization of a response to the hierarchical system command cannot be rendered based on a present population level of the hierarchical system hierarchy;
in response to the act of determining, an act of identifying data that would increase the local hierarchical system to a higher population level that could be used to render the visualization of the response to the hierarchical system command, the higher population level being less than full population of the hierarchical system hierarchy;
in response to the act of identifying, an act of obtaining the identified data from a remote location; and
an act of populating the obtained identified data into the local hierarchical system.

2. The system in accordance with claim 1, the hierarchical system being a file system and the hierarchy of the hierarchical system being a directory structure.

3. The system in accordance with claim 2, wherein after the populating the obtained identified data into the local hierarchical system, the hierarchical system command interception component issues the file system command to the file system.

4. The system in accordance with claim 1, the remote location being a cloud computing environment.

5. A method for a hierarchical system request interception component to provide an appearance of a populated hierarchical system hierarchy even for a local hierarchical system having an incompletely populated hierarchy, the method comprising:
an act of intercepting a hierarchical system command issued to the local hierarchical system that has the incompletely populated hierarchy;
in response to the act of intercepting, an act of determining that a visualization of a response to the hierarchical system command cannot be rendered based on a present population level of the local hierarchical system hierarchy;
in response to the act of determining, an act of identifying data that would increase the local hierarchical system to a higher population level that could be used to render the visualization of the response to the hierarchical system command, the higher population level being less than full population of the local hierarchical system hierarchy;
in response to the act of identifying, an act of obtaining the identified data from a remote location; and
an act of populating the obtained identified data into the local hierarchical system.

6. The method in accordance with claim 5, the hierarchical system being a file system and the hierarchy of the hierarchical system being a directory structure.

7. The method in accordance with claim 5, wherein the method is repeatedly performed responsive to successive file system commands to gradually increase the population of the hierarchy of the file system.

8. The method in accordance with claim 7, wherein when the method is first performed with respect to the first file system command issued to the file system, the hierarchy of the file system is populated with a root directory.

9. The method in accordance with claim 7, wherein when the method is first performed with respect to the first file system command issued to the file system, the hierarchy of the file system is populated with multiple subdirectories, each corresponding to file system state at a corresponding time.

10. The method in accordance with claim 9, the file system command corresponding to the file system as it existed at a particular time, the obtained data from the remote location being data as it existed in the file system at the particular time, the obtained data being used to populate a subdirectory that corresponds to the particular time.

11. The method in accordance with claim 9, wherein when the method is first performed with respect to the first file system command issued to the file system, the hierarchy of the file system is populated with boot files that permit the computing system that hosts the file system to be booted.

12. The method in accordance with claim 5, the file system command being a directory content listing command to list contents of a directory, the contents of the directory not being within the incompletely populated hierarchy.

13. The method in accordance with claim 12, the identified data being names of content nodes of the directory.

14. The method in accordance with claim 12, the identified data being metadata of the content nodes of the directory.

15. The method in accordance with claim 12, the identified data not including at least the majority of the content at least the majority of the content nodes of the directory.

16. The method in accordance with claim 5, the file system command identifying a file system path, at least a portion of the file system path not existing in the incompletely populated hierarchy of the file system.

17. The method in accordance with claim 16, the act of obtaining the identified data from a remote location data comprising:
an act of performing the following beginning at most ancestral node in the portion of the file system path not existing in the file system path and continuing to the leaf node in the portion of the file system path not existing in the file system to the:
an act of identifying the corresponding node;
an act of using the identification of the corresponding node to access an injected representation of the corresponding node and reversal information of the corresponding node; and
an act of using the reversal information to obtain the original representation of the corresponding node, which identifies one or more child nodes of the corresponding node, including the next descendent node in the file system path.

18. A computer program product comprising one or more computer-readable storage media having thereon computer-executable instructions that are structured such that, when executed by one or more processors of the computing system, the computing system is caused to operate and/or instantiate a first system command interception component that performs a method comprising the following in response to in response to intercepting a hierarchical system command issued to a local hierarchical system that has the incompletely populated hierarchy:
in response to the act of intercepting, an act of determining that a visualization of a response to the hierarchical system command cannot be rendered based on a present population level of the local hierarchical system hierarchy;
in response to the act of determining, an act of identifying data that would increase the local hierarchical system to a higher population level that could be used to render the visualization of the response to the hierarchical system command, the higher population level being less than full population of the local hierarchical system hierarchy; and
in response to the act of identifying, an act of obtaining the identified data from a remote location data.

19. The computer program product in accordance with claim 18, wherein the method is repeatedly performed responsive to successive hierarchical system commands to gradually increase the population of the hierarchy of the hierarchical system.

20. The computer program product in accordance with claim 18, the hierarchical system being a file system, the hierarchical system command being a file system command, the file system command identifying a file system path, at least a portion of the file system path not existing in the incompletely populated hierarchy of the file system, the act of obtaining the identified data from a remote location data comprising an act of performing the following beginning at most ancestral node in the portion of the file system path not existing in the file system path and continuing to the leaf node in the portion of the file system path not existing in the file system:
an act of identifying the corresponding node;
an act of using the identification of the corresponding node to access an injected representation of the corresponding node and reversal information of the corresponding node; and
an act of using the reversal information to obtain the original representation of the corresponding node, which identifies one or more child nodes of the corresponding node, including the next descendent node in the file system path.
